(19) United States
(12) Patent Application Publication
(10) Pub. No.: US 2017/0124922 A1
(43) Pub. Date: May 4, 2017

(54) FLUORESCENT FLEX SHEET AND METHOD OF MANUFACTURING THE SAME

(71) Applicant: GLLEPE CO., LTD., Daegu (KR)

(72) Inventor: HEE JUN KIM, Gumi-si, Gyeongsangbuk-do (KR)

(73) Assignee: GLLEPE CO., LTD., Daegu (KR)

(21) Appl. No.: 15/102,526

(22) PCT Filed: Apr. 26, 2016
(86) PCT No.: PCT/KR2016/004352

§ 371 Date: Jun. 7, 2016

(30) Foreign Application Priority Data
Jun. 5, 2015 (KR) 10-2015-0079704

(51) Int. Cl. G09F 13/04; G09F 13/22; B32B 37/14; B32B 27/18; B32B 5/02

(52) U.S. Cl. CPC G09F 13/04; B32B 27/18; B32B 5/02; B32B 37/14; G09F 13/22; B32B 2590/00; B32B 2307/412; B32B 2307/422; G09F 2013/222

(57) ABSTRACT

Provided are a fluorescent flex sheet and a method of manufacturing the same. More specifically, a fluorescent flex sheet which is a sheet for a sign containing a fluorescent substance, and is easily applicable to a sign having a large area, and may implement high brightness, excellent visibility, light stability, durability, and weather resistance, and a method of manufacturing the same are provided.

### TECHNICAL FIELD

The present invention relates to a fluorescent flex sheet and a method of manufacturing the same. More specifically, the present invention relates to a fluorescent flex sheet which is a sheet for a sign containing a fluorescent substance, and is easily applicable to a sign having a large area, and may implement high brightness, excellent visibility, light stability, durability, and weather resistance, and a method of manufacturing the same.

### BACKGROUND ART

A polyvinyl chloride (PVC) resin laminated sheet used as an advertising sign is easy to handle, applicable for a variety of uses, and widely used, ranging from a small sign to a large sign as well. In particular, it is easy to be installed, simple, and not easily bent or damaged, and thus, is in demand. The polyvinyl chloride resin laminated sheet has excellent flexibility, and may be formed into a gel phase, thereby allowing a process such as a calender process to be simple. A sheet applicable to an advertising sign and the like with excellent flexibility, such as this polyvinyl chloride resin laminated sheet is called, a flex sheet.

However, in the case of an outdoor sign exposed to the outside, the sign was manufactured using a neon sign utilizing a glass tube, or an acrylic board which is light-distributed with a plurality of fluorescent lamps, however, high electrical power and voltage are needed, thereby deteriorating safety and constructability, and increasing a maintenance cost and reducing a life span, and thus, it is not economical. Further, the acrylic sign which is light-distributed with a plurality of fluorescent lamps is thick, due to a large number of fluorescent lamps and complicated electrical wiring, thereby spoiling the appearance of a building.

Accordingly, an advertising sign capable of reducing energy, having a simple structure, and having a beautiful appearance is increasingly needed.

### DISCLOSURE OF INVENTION

### Technical Problem

The present invention was made in order to solve the above problems, and an object of the present invention is to provide a fluorescent flex sheet containing a fluorescent substance, and capable of implementing excellent visibility, light diffusing property, durability and weather resistance.

Further, another object of the present invention is to provide a fluorescent flex sheet being easily applicable to a sign having a large area, and having excellent handling property and workability.

Further, another object of the present invention is to provide an advertising sign including the fluorescent flex sheet, using a low power interior light emitting lighting, thereby phenomenally reducing energy, and having a simple structure, thereby improving safety and constructability.

### Solution to Problem

In one general aspect, a fluorescent flex sheet includes an upper substrate layer, a fabric layer, and a fluorescent sheet layer which are sequentially laminated,

wherein a light emitting device is disposed in a direction of the fluorescent sheet layer, so that the fluorescent flex sheet emits light having a different color from that of a lamp of the light emitting device, in a direction of the upper substrate layer.

In the fluorescent flex sheet according to an exemplary embodiment of the present invention, the fluorescent sheet layer may be obtained by molding-processing a mixture including a fluorescent pellet into a sheet.

In the fluorescent flex sheet according to an exemplary embodiment of the present invention, the fluorescent pellet may include a fluorescent ink composition, a base resin, and a reinforcement.

In the fluorescent flex sheet according to an exemplary embodiment of the present invention, it is preferred that the fluorescent ink composition includes 5 to 25 wt %, preferably 10 to 20 wt % of the fluorescent substance based on the total composition, for improving optical properties. Further, it is more preferred that the fluorescent ink composition includes 10 to 50 wt % of a binder resin, 5 to 25 wt % of a fluorescent substance, and 40 to 70 wt % of a solvent, for satisfying the desired effect of the present invention, but not necessarily limited thereto.

In the fluorescent flex sheet according to an exemplary embodiment of the present invention, the binder resin may include 5 to 40 wt % of a polyester-based resin, 10 to 45 wt % of an acryl-based resin, 5 to 30 wt % of a cellulose-based resin, and 5 to 20 wt % of a diluent, and it is more preferred that the range is satisfied, in terms of optical properties such as light transmittance and haze, as well as device storage stability.

In the fluorescent flex sheet according to an exemplary embodiment of the present invention, the upper substrate layer may be a transparent or white sheet.

In the fluorescent flex sheet according to an exemplary embodiment of the present invention, the fabric may be formed by weaving any one or more fibers selected from the group consisting of polyester, polyamide, polyacryl, natural fiber, and rayon.

In the fluorescent flex sheet according to an exemplary embodiment of the present invention, the lower substrate layer may be a transparent or white sheet.

In another general aspect, a method of manufacturing a fluorescent flex sheet includes subjecting a composition for preparing a fluorescent pellet including a fluorescent ink composition, a base resin, and a reinforcement to melt extrusion to obtain a fluorescent pellet, subjecting the obtained fluorescent pellet to a molding process to manufacture a fluorescent sheet, and laminating a fabric layer and an upper substrate layer sequentially on the manufactured fluorescent sheet.

In the method of manufacturing a fluorescent flex sheet according to an exemplary embodiment of the present invention, the fluorescent ink composition in the composition for preparing a fluorescent pellet may include 10 to 50 wt % of a binder resin, 10 to 25 wt % of a fluorescent substance, and 40 to 70 wt % of a solvent.

In the method of manufacturing a fluorescent flex sheet according to an exemplary embodiment of the present invention, the binder resin may include 5 to 40 wt % of a polyester-based resin, 10 to 45 wt % of an acryl-based resin, 5 to 30 wt % of a cellulose-based resin, and 5 to 20 wt % of a diluent.

In the method of manufacturing a fluorescent flex sheet according to an exemplary embodiment of the present invention, component contents in the fluorescent pellet are not significantly limited, but it is preferred that the fluorescent ink composition is included at 5 to 25 wt %, more preferably 10 to 25 wt %, for improving optical properties. Further, the fluorescent pellet may further include an additive such as a plasticizer, a heat stabilizer, a UV block, a light diffusing agent, titanium dioxide and an antibiotic, but not necessarily limited thereto.

In the method of manufacturing a fluorescent flex sheet according to an exemplary embodiment of the present invention, the fabric layer may be formed of a fabric obtained by weaving any one or more fibers selected from the group consisting of polyester, polyamide, polyacryl, natural fiber, and rayon.

In the method of manufacturing a fluorescent flex sheet according to an exemplary embodiment of the present invention, the upper substrate layer may be a transparent or white sheet.

In the method of manufacturing a fluorescent flex sheet according to an exemplary embodiment of the present invention, the manufacturing of the fluorescent sheet may further include embossing by a subsequent process.

In still another general aspect, an advertising sign includes the fluorescent flex sheet of any one as described above, a light source, and a power supply part supplying power to the light source.

In the advertising sign according to an exemplary embodiment of the present invention, the light source may include a printed circuit board to which external power is applied, and at least one light emitting element formed on the printed circuit board.

### Advantageous Effects of Invention

The fluorescent flex sheet according to the present invention has advantages of having excellent visibility and light diffusing property, and phenomenally improving durability and weather resistance.

The fluorescent flex sheet according to the present invention has advantages of having excellent flexibility, having no limitation on length and width as compared with conventional boards made of hard materials, thereby being easily applicable to a sign having a large area, and being easily handled and constructed.

Further, the advertising sign including the fluorescent flex sheet according to the present invention has advantages of using an interior light emitting lighting having low power and a long life, thereby phenomenally reducing energy, and having a simple structure, thereby improving safety and constructability.

### BRIEF DESCRIPTION OF DRAWINGS

The above and other objects, features and advantages of the present invention will become apparent from the following description of preferred embodiments given in conjunction with the accompanying drawings, in which:

FIG. 1 briefly illustrates an advertising sign including a fluorescent flex sheet according to an exemplary embodiment of the present invention.

### DETAILED DESCRIPTION OF MAIN ELEMENTS

11: Upper substrate layer
12: Fabric layer
13: Fluorescent sheet layer
21: Light source
22: Printed circuit board
100: Fluorescent flex sheet
200: Light emitting assembly

### BEST MODE FOR CARRYING OUT THE INVENTION

Hereinafter, the fluorescent flex sheet of the present invention and a method of manufacturing the same will be described in detail. The exemplary embodiments of the present invention described below are provided by way of example so that the idea of the present invention can be sufficiently transferred to a person skilled in the art. In addition, technical terms and scientific terms used in the present specification have the general meaning understood by a person skilled in the art unless otherwise defined, and a description for the known function and configuration obscuring the present invention will be omitted in the following description.

In order to achieve the object as described above, the fluorescent flex sheet of the present invention includes an upper substrate layer, a fabric layer, and a fluorescent sheet layer which are sequentially laminated, wherein a light emitting device is disposed in a direction of the fluorescent sheet layer, so that the fluorescent flex sheet emits light having a different color from that of a lamp of the light emitting device, in a direction of the upper substrate layer.

In the present invention, the fluorescent flex sheet may be obtained by molding-processing a mixture including a fluorescent pellet into a sheet. The fluorescent sheet manufactured by forming a fluorescent pellet into a sheet is integrated by laminating a fabric layer and an upper substrate layer thereon. The durability and weather resistance of the fluorescent flex sheet of the present invention may be improved by a combination including the fluorescent sheet. Further, a light diffusing property and light emitting efficiency may be maximized.

The fluorescent pellet may include a fluorescent ink composition, a base resin, and a reinforcement. Here, the fluorescent ink composition may include a binder resin, a fluorescent substance and a solvent.

The fluorescent ink composition may include preferably 10 to 50 wt % of the binder resin, 5 to 25 wt % of the fluorescent substance, and 40 to 70 wt % of the solvent, but not significantly limited thereto. It is preferred that the range is satisfied, for implementing high brightness, long term durability and weather resistance.

The binder resin may include 5 to 40 wt % of a polyester-based resin, 10 to 45 wt % of an acryl-based resin, 5 to 30 wt % of a cellulose-based resin, and 5 to 20 wt % of a diluent.

The polyester-based resin may be prepared by polycondensation of a polybasic acid and a polyhydric alcohol. The polybasic acid is not significantly limited, but as a preferred example, may be an aromatic-based saturated dibasic acid such as phthalic anhydride, isophthalic acid and terephthalic acid, an unsaturated dibasic acid such as maleic anhydride, fumaric acid, itaconic acid and citraconic acid, tribasic acid such as trimellitic anhydride, and the like. Further, as a derivative of the polybasic acid, an aliphatic-based saturated dibasic acid such as adipic acid, azelaic acid, sebacic acid, tetrahydrophthalic anhydride, hexahydrophthalic anhydride, tetrachlorophthalic anhydride may be used. The polyhydric alcohol is not significantly limited, but preferably a mixture of diols having a branched chain or polyols higher than an acid value may be used. As an example of a diol having a branched chain, neo-pentyl glycol, 1,4-butanediol, propylene glycol and the like may be listed, and as a trihydric polyol or higher, trimethyrol propane, pentaerythritol, glycerin and the like may be listed.

The polyester-based resin may be included at 5 to 40 wt %, preferably 5 to 30 wt %, based on the total weight of the binder resin.

The polyester-based resin may have a weight average molecular weight of 10,000 to 100,000 g/mol, preferably 20,000 to 50,000 g/mol. Further, the polyester-based resin may be acryl-modified polyester. It is preferred that the range is satisfied, since miscibility with the components in the binder resin is excellent, viscosity is easily controlled, and excellent smoothness, dispersibility and uniformity may be implemented when forming a coating layer.

The acryl-based resin may include a mixture of any one or two or more selected from the group consisting of acryl polyol, an acrylic acid copolymer, a modified acrylic acid copolymer and polyacrylate. As a preferred example of the acryl-based resin, the resin prepared by adding a monomer selected from the group consisting of alkyl glycidyl ether acrylate having 2 to 8 carbon atoms such as acrylic acid, methacrylic acid, ethyl glycidyl ether acrylate, ethyl glycidyl ether methacrylate, propyl glycidyl ether acrylate, propyl glycidyl ether methacrylate and butyl glycidyl ether methacrylate; benzimidazole, methyl methacrylate, methyl alcohol acrylate, glycidyl methacrylate, phenyl glycidyl ether acrylate, phenyl glycidyl ether methacrylate; tricyclodecyl methacrylate, phenyl acrylate, phenyl methacrylate, benzyl acrylate, benzyl methacrylate, 2- or 4-methoxyphenyl acrylate, 2- or 4-methoxyphenyl methacrylate, 2- or 4-methoxybenzyl acrylate, 2- or 4-methoxybenzyl methacrylate, 2- or 4-ethoxyphenyl acrylate, 2- or 4-ethoxyphenyl methacrylate, 2- or 4-ethoxybenzyl acrylate, 2- or 4-ethoxybenzyl methacrylate, 2- or 4-chlorophenyl acrylate, 2- or 4-chlorophenyl methacrylate, 2- or 4-chlorobenzyl acrylate, 2- or 4-chlorobenzyl methacrylate, 2- or 4-bromophenyl acrylate, 2- or 4-bromophenyl methacrylate, 2- or 4-bromobenzyl acrylate, and 2- or 4-bromobenzyl methacrylate with an initiator, and carrying out polymerization by a general method may be used, but not necessarily limited thereto. Preferably, an acryl polyol resin may be used. The acryl polyol resin may be used for maximizing optical properties. An acryl copolymer obtained by polymerizing a mixture of a monovinyl monomer and a divinyl monomer using an initiator may be used, and it is more preferred that the content of non-volatile components is 40 to 70 wt %, Gardner bubble viscosity is N to Z 5, an acid value is 0 to 10, and color is 0 to 3. Here, as the divinyl monomer, a divinyl methacrylate monomer may be used. When it is mixed with a cellulose-based resin having a butylate group and a propionate group, it is preferred to use long-chain divinyl (meth)acrylate having a plurality of hydrocarbon compounds.

The acryl-based resin may be included at 10 to 45 wt %, preferably 10 to 40 wt %, based on the total weight of the binder resin mixture.

When the content of non-volatile components is less than 40 wt %, the content of a volatile solvent may be increased, and the time for forming a coated film may become longer, thereby deteriorating gloss and visibility, and when more than 70 wt %, synthesis may proceed at high viscosity, and miscibility with a cellulose-based resin may be poor. Further, when the Gardner bubble viscosity is less than N, viscosity and a molecular weight may be lowered, and when more than Z 5, an additional dilution solvent is needed due to high viscosity, which causes increase of an organic volatile solvent.

Further, it is preferred that the acryl polyol resin has a hydroxyl group content of 1 to 3 wt % relative to non-volatile components in the resin composition, and a molecular weight distribution of 1.0 to 6.0, for physical properties and chemical resistance properties.

The cellulose-based resin may be cellulose ester, alkyl cellulose or nitrocellulose, preferably any one or two or more cellulose esters selected from the group consisting of cellulose acetate, cellulose propionate, cellulose butyrate, cellulose acetate propionate, cellulose acetate butyrate, cellulose acetate phthalate and cellulose phthalate.

The cellulose-based resin may have a weight average molecular weight (Mw) of 30,000 to 40,000, and it is preferred that the cellulose-based resin is mixed with an acryl-based resin at a mixing weight ratio of 1:1.5 to 1:5, for miscibility, dispersion stability of a composition, and yellowing inhibition.

The diluent may be a solvent selected from the group consisting of dimethyl cyclohexyl amine, methyl ethyl ketone, cyclohexanone, propylene glycol monomethyl ether, ethylene glycol monobutyl ether acetate, xylene, ethyl acetate, dipropylene glycol monomethyl ether, normal butyl. acetate, butyl glycol, and a mixture thereof.

The fluorescent substance may be an inorganic or organic fluorescent substance, but not limited thereto, and a general fluorescent substance may be used. Preferably, it may be an organic EL or inorganic EL, or hybrid-type EL in which the organic EL or inorganic EL is mixed.

The fluorescent substance according to the present invention may be, by way of example, SDY555-7, R625 and the like available from YANTAI SHIELD ADVANCED MATERIALS, but not necessarily limited thereto.

The fluorescent ink composition according to an exemplary embodiment of the present invention may have a viscosity of 5,000 to 30,000 CP. When the viscosity range is satisfied, light loss may be reduced, and light transmittance may be maximized by stable dispersion of the fluorescent agent, and durability and weather resistance may be improved.

In the present invention, the upper substrate layer may be composed of materials capable of diffusing light received from a light source to the outside. Such materials may be any one or more selected from the group consisting of a polyvinyl chloride resin sheet, an acryl sheet, a polycarbonate sheet, and glass or a white sheet, and preferably a light diffusing polyvinyl chloride resin sheet may be used. It is preferred that this is integrated with a fabric layer disposed thereunder, thereby having an excellent adhesive property and imparting flexibility. By way of example, a PVC resin (LS-100S) from LG Chem., may be used.

The fabric layer disposed under the upper substrate layer may be used for a reinforcing property and dimensional stability which impart flexibility of the fluorescent flex sheet, and improve strength. This fabric layer is not significantly limited, but may be formed by weaving any one or more fibers selected from the group consisting of polyester, polyamide, polyacryl, natural fiber, and rayon. Preferably, high strength polyester fabric manufactured by weaving polyester may be used. Otherwise, glass fiber cloth, glass fabric, glass non-woven fabric, glass fiber mesh, and the like may be used, but not limited thereto. Further, denier (D) of the fabric layer may be adjusted when woven, and it is more preferred to use those in a range of 100 to 1,000 denier, preferably 300 to 600 denier, for the effects of increasing optical properties, durability, and weather resistance of the fluorescent flex sheet.

The method of manufacturing the fabric layer is not significantly limited, but the fabric layer may be manufactured using a method such as spun bonding, thermal fusion, bicomponent, spunlace, melt blowing, dry lamination and chemical bonding.

When the fluorescent flex sheet according to the present invention is exposed to an external environment, it is preferred that moisture resistance and waterproof properties are imparted to the sheet, so that the sheet has durability under various climates. Thus, an adhesive layer or an adhesive sheet having moisture resistance and water proof properties may be further included between the upper substrate layer and the fabric layer. As the adhesive layer or adhesive sheet, preferably polyolefin, polyester, a polyurethane-polyester copolymer having excellent transparency or the like may be used, and more preferably polyolefin may be used.

In the present invention, the fluorescent sheet layer may serve as a protective layer protecting the sheet from impact which may occur from the outside, and at the same time contain a fluorescent substance to implement high brightness. Further, it has excellent durability and weather resistance, thereby having a characteristic of long term life, and allows an actual image to be printed out by digital printing.

The present invention provides a method of manufacturing a fluorescent flex sheet including:

subjecting a masterbatch composition including a fluorescent ink composition, a base resin, and a reinforcement to melt extrusion to obtain a fluorescent pellet,

subjecting the obtained fluorescent pellet to a molding process to manufacture a fluorescent sheet, and

laminating a fabric layer and an upper substrate layer sequentially on the manufactured fluorescent sheet.

In the present invention, the method of manufacturing the fluorescent flex sheet includes manufacturing a fluorescent sheet using a fluorescent pellet, and laminating a fabric layer and an upper substrate layer sequentially on the fluorescent sheet.

The fluorescent pellet may be prepared using a composition for preparing a fluorescent pellet. The composition for preparing the fluorescent pellet is a mixture for preparing the fluorescent pellet, and includes the fluorescent ink composition as described above, a base resin, and a reinforcement. Here, the base resin may be a transparent or white resin, and as the base resin, a polyvinyl chloride resin, a poly carbonate resin, an acryl resin and the like may be used, but not significantly limited thereto. Preferably, a light diffusing polyvinyl chloride resin may be used. Further, as the kind of reinforcement, glass fiber, glass fabric, glass non-woven fabric, glass beads, glass powder, glass flake, silica particles, colloidal silica, and the like may be listed, but not necessarily limited thereto. As this reinforcement, the one which was impregnated in the base resin among the components for preparing the fluorescent pellet, and then subjected to crosslinking, may be use.

The composition for preparing the fluorescent pellet is subjected to melt extrusion at 150 to 180° C., and then is cut, thereby being formed into a pellet for molding. The size of the pellet for molding is not limited, and may be adjusted as required. The thus-prepared fluorescent pellet is formed into a sheet through a molding process. As a molding processing method, a calender process or a casting process may be utilized, but not necessarily limited thereto.

In the present invention, the thickness of the fluorescent sheet is not limited, but the fluorescent sheet may have a thickness of preferably 5 to 40%, more preferably 10 to 20% of the total thickness of the sheet. It is preferred that the range is satisfied, for implementing an increasing effect of optical properties such as color temperature and illuminance.

The fluorescent sheet may be formed into a sheet through a molding process, and then embossed on the sheet by an embossing process. In the embossing process, embossing may be carried out in the internal lattice space of the fabric layer, while the fabric layer and upper substrate layer are sequentially laminated. Otherwise, embossing may be carried out by pressure molding using an embossing roller. Here, it is preferred that embossing is carried out by maintaining the temperature of the embossing roller at 40 to 120° C., and applying a pressure of 80 kgf/cm² to 100 kgf/cm².

The fluorescent flex sheet of the present invention may be formed into a laminate by laminating the fabric layer and upper substrate layer sequentially on the manufactured fluorescent sheet. The thus-manufactured laminate, that is, the fluorescent flex sheet may be dried by a common method using an oven, hot air, or the like. For example, the final sheet may be finally dried in a chiller zone by passing through a pan and a cooler drum. Here, the drying temperature range is not significantly limited, but may be preferably 40 to 120° C.

The present invention provides an advertising sign including the fluorescent flex sheet of any one as described above, a light source, and a power supply part supplying power to the light source.

In the advertising sign according to an exemplary embodiment of the present invention, the light source may include a printed circuit board to which external power is applied, and at least one light emitting device formed on the printed circuit board.

The present invention may include a light source supplying device such as a back light unit, as a light emitting element. Here, the back light unit may be classified into a bottom type and an edge type depending on the position of a light source, and the position of a light source is not necessarily limited, and the light source may be disposed in various positions, thereby supplying light to the flex sheet.

The fluorescent flex sheet according to an exemplary embodiment of the present invention includes the light source, thereby implementing better visibility and light diffusing property in a color temperature range of 5,000 K to 100,000 K. Here, it is preferred that LED forming the light source uses cool white or blue, but not necessarily limited thereto.

The fluorescent flex sheet according to the present invention is not limited to the interior of the advertising sign, but low power blue LED may be used as an internal lighting. In this case, it may cut down expenses, and due to its long life, reduce extra expense caused by replacement and management, as compared with white LED. In particular, high brightness may be implemented by using the blue LED as an internal lighting, and white light may be directly implemented in the flex sheet, thereby emitting uniform light to the outside even in the case of saving power of the internal light source. Further, it is possible to print out an actual image by digital printing. Further, the fluorescent flex sheet according to the present invention may have no limitation on length and width as compared with conventional boards made of hard materials, thereby being applied to a sign having a large area, be slimmed to have excellent constructability and workability, and implement excellent durability and weather resistance.

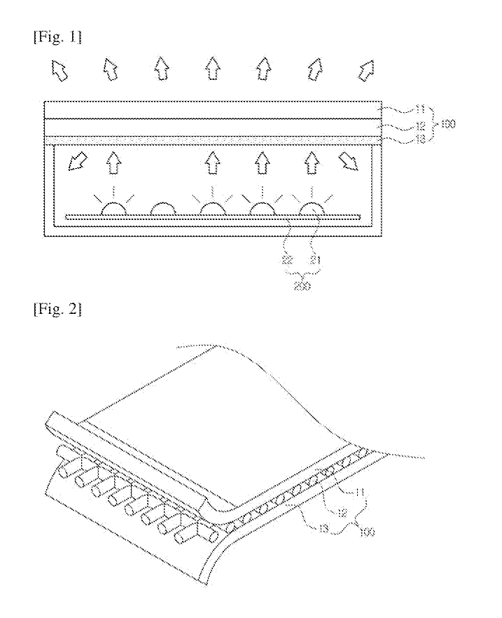

FIG. 1 briefly represents a structure of an advertising sign including the fluorescent flex sheet according to an exemplary embodiment of the present invention, in which the fluorescent flex sheet 100 is formed by laminating an upper substrate layer 11, a fabric layer 12, and a fluorescent sheet layer 13 sequentially. Further, a light emitting assembly 200 is disposed at a regular distance from the fluorescent flex sheet. A frame which may be combined with the fluorescent flex sheet 100 to form internal space is formed, as in FIG. 1, thereby manufacturing a sign. In the space, the light emitting assembly 200 may be accommodated. The light emitting assembly 200 includes alight source 21 and a printed circuit board 22 which may transmit power and appropriate signals to the light source.

Hereinabove, although the present invention has been described by specific exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1. A fluorescent flex sheet comprising an upper substrate layer, a fabric layer, and a fluorescent sheet layer which are sequentially laminated, wherein a light emitting device is disposed in a direction of the fluorescent sheet layer, so that the fluorescent flex sheet emits light having a different color from a color of a lamp of the light emitting device, in a direction of the upper substrate layer.

2. The fluorescent flex sheet of claim 1, wherein the fluorescent sheet layer is obtained by molding-processing a mixture including a fluorescent pellet into a sheet.

3. The fluorescent flex sheet of claim 2, wherein the fluorescent pellet includes a fluorescent ink composition, a base resin, and a reinforcement.

4. The fluorescent flex sheet of claim 3, wherein the fluorescent ink composition includes 10 to 50 wt % of a binder resin, 10 to 25 wt % of a fluorescent substance, and 40 to 70 wt % of a solvent.

5. The fluorescent flex sheet of claim 4, wherein the binder resin includes 5 to 40 wt % of a polyester-based resin, 10 to 45 wt % of an acryl-based resin, 5 to 30 wt % of a cellulose-based resin, and 5 to 20 wt % of a diluent.

6. The fluorescent flex sheet of claim 1, wherein the upper substrate layer is a transparent or white sheet.

7. The fluorescent flex sheet of claim 1, wherein the fabric layer is formed by weaving any one or more fibers selected from the group consisting of polyester, polyamide, polyacryl, natural fiber, and rayon.

8. A method of manufacturing a fluorescent flex sheet, comprising:
subjecting a composition for preparing a fluorescent pellet including a fluorescent ink composition, a base resin and a reinforcement to melt extrusion to obtain a fluorescent pellet,
subjecting the obtained fluorescent pellet to a molding process to manufacture a fluorescent sheet, and
laminating a fabric layer and an upper substrate layer sequentially on the fluorescent sheet.

9. The method of claim 8, wherein the fluorescent ink composition in the composition for preparing the fluorescent pellet includes 10 to 50 wt % of a binder resin, 10 to 25 wt % of a fluorescent substance, and 40 to 70 wt % of a solvent.

10. The method of claim 9, wherein the binder resin includes 5 to 40 wt % of a polyester-based resin, 10 to 45 wt % of an acryl-based resin, 5 to 30 wt % of a cellulose-based resin, and 5 to 20 wt % of a diluent.

11. The method of claim 8, wherein the fabric layer is formed by a fabric obtained by weaving any one or more fibers selected from the group consisting of polyester, polyamide, polyacryl, natural fiber, and rayon.

12. The method of claim 8, wherein the upper substrate layer is a transparent or white sheet.

13. The method of claim 8, wherein subjecting of the obtained fluorescent pellet to a molding process to manufacture a fluorescent sheet further includes embossing as a subsequent process.

14. An advertising sign comprising the fluorescent flex sheet of claim 1, a light source, and a power supply part supplying power to the light source.

15. The advertising sign of claim 14, wherein the light source includes a printed circuit board to which external power is applied, and at least one light emitting device formed on the printed circuit board.
